(19) United States
(12) Patent Application Publication
(10) Pub. No.: US 2020/0266470 A1
(43) Pub. Date: Aug. 20, 2020

(54) FUEL CELL AND MANUFACTURING METHOD THEREOF

(71) Applicants: Hyundai Motor Company, Seoul (KR); Kia Motors Corporation, Seoul (KR)

(72) Inventors: Seong Hak Kim, Busan (KR); Woo Jin Lee, Seoul (KR)

(21) Appl. No.: 16/570,570

(22) Filed: Sep. 13, 2019

(30) Foreign Application Priority Data
Feb. 19, 2019 (KR) 10-2019-0019215

(51) Int. Cl. H01M 8/1004; H01M 8/0273; H01M 4/88

(52) U.S. Cl. CPC H01M 8/1004; B32B 2457/18; H01M 4/881; H01M 8/0273

(57) ABSTRACT

A fuel cell includes an electrolyte membrane, first and second electrode layers disposed on first and second surfaces of the electrolyte membrane, respectively, the second surface being opposite to the first surface. One of the first and second electrode layers is an anode electrode layer and the other is a cathode electrode layer. Additionally, first and second gaskets are disposed on the first and second surfaces of the electrolyte membrane, respectively, to be adjacent to an edge of the electrolyte membrane. The first electrode layer includes a first main electrode layer disposed on the first surface of the electrolyte membrane and inside the first gasket and a first sub-electrode layer having a first portion inserted between the first main electrode layer and the electrolyte membrane and a second portion inserted between the first gasket and the electrolyte membrane.

### CROSS-REFERENCE TO RELATED APPLICATION

This application is claims the benefit of priority to Korean Patent Application No. 10-2019-0019215, filed on Feb. 19, 2019, the entire contents of which are incorporated herein by reference.

### TECHNICAL FIELD

The present disclosure relates to a fuel cell and a manufacturing method thereof, and more particularly, to a fuel cell having a structure that prevents separation between an electrolyte membrane and a gasket of the fuel cell, and a method for manufacturing the fuel cell.

### BACKGROUND

Fuel cell systems, which continually produce electrical energy through an electro-chemical reaction of fuel continuously supplied thereto, have been consistently studied and developed as an alternative for solving global environmental problems. The fuel cell systems may be classified into a phosphoric acid fuel cell (PAFC), a molten carbonate fuel cell (MCFC), a solid oxide fuel cell (SOFC), a polymer electrolyte membrane fuel cell (PEMFC), an alkaline fuel cell (AFC), and a direct methanol fuel cell (DMFC) based on the types of electrolytes used. The fuel cell systems may be applied to various applications, such as mobile power supply, transportation, distributed power generation, and the like, based on operating temperatures and output ranges along with the types of fuels used.

Among the fuel cells mentioned above, the PEMFC is applied to a hydrogen vehicle (a hydrogen fueled cell vehicle) that is being developed to replace an internal combustion engine. The hydrogen vehicle is driven by producing electricity through an electro-chemical reaction of hydrogen and oxygen and operating a motor with the electricity produced. Accordingly, the hydrogen vehicle includes a hydrogen (H₂) tank for storing hydrogen (H₂), a fuel cell stack (FC stack) for producing electricity through oxidation/reduction reactions of hydrogen (H₂) and oxygen (O₂), various apparatuses for draining water produced, a battery for storing the electricity produced by the fuel cell stack, a controller that converts and adjusts the electricity produced, a motor for generating a driving force, and the like.

The fuel cell stack refers to a fuel cell body having tens or hundreds of cells stacked in series. The cells are stacked between end plates, each cell including an electrolyte membrane that divides the interior of the cell into two parts, an anode on a first side of the electrolyte membrane, and a cathode on a second side thereof. A separator is disposed between the cells to restrict flow paths of hydrogen and oxygen. The separator is made of a conductor to move electrons during oxidation/reduction reactions.

When hydrogen is supplied to the anode, the hydrogen is divided into hydrogen ions and electrons by a catalyst. The electrons produce electricity while moving outside the fuel cell stack through the separator. The hydrogen ions pass through the electrolyte membrane and move to the cathode, after which the hydrogen ions are combined with oxygen supplied from ambient air and electrons to produce water, and the water produced is discharged to the outside. Each of the fuel cells of the fuel cell stack generally includes an electrolyte membrane, an anode electrode layer and a cathode electrode layer on opposite sides of the electrolyte membrane, and sub-gaskets on the opposite sides of the electrolyte membrane.

When the sub-gaskets are bonded to the electrolyte membrane, the sub-gaskets are preferably brought into close contact with the electrolyte membrane without an empty space therebetween. Otherwise, water produced by an electro-chemical reaction at the anode or the cathode may flow to the electrolyte membrane through an empty space causing degradation in durability of the electrolyte membrane. When the sub-gaskets are bonded to the electrolyte membrane, it is preferable to minimize the gaps between the sub-gaskets and the electrode layers. If the gaps between the sub-gaskets and the electrode layers are widened to directly expose the electrolyte membrane to hydrogen or air, gas permeates across the electrolyte membrane from the anode to the cathode or vice versa, and the electrolyte membrane may be damaged. Accordingly, a fuel cell having an improved structure is required to improve vulnerability of a bonding structure between an electrolyte membrane and a gasket and enhance durability of the electrolyte membrane.

### SUMMARY

The present disclosure provides a fuel cell for improving vulnerability of a bonding structure between an electrolyte membrane and a gasket. Another aspect of the present disclosure provides a fuel cell for enhancing durability of an electrolyte membrane and hence power generation performance of the fuel cell. The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell may include an electrolyte membrane, a first electrode layer and a second electrode layer disposed on a first surface and a second surface of the electrolyte membrane, respectively, the second surface being opposite to the first surface, in which one of the first and second electrode layers is an anode electrode layer and the other is a cathode electrode layer, and a first gasket and a second gasket disposed on the first surface and the second surface of the electrolyte membrane, respectively, to be adjacent to an edge of the electrolyte membrane. The first electrode layer may include a first main electrode layer disposed on the first surface of the electrolyte membrane and inside the first gasket and a first sub-electrode layer having a portion inserted between the first main electrode layer and the electrolyte membrane and a portion inserted between the first gasket and the electrolyte membrane.

According to another aspect of the present disclosure, a method for manufacturing a fuel cell may include preparing an intermediate electrolyte-membrane product that includes an electrolyte membrane and a first sub-electrode layer formed on a first surface of the electrolyte membrane, bonding a first gasket and a second gasket to the first surface and a second surface of the electrolyte membrane, respectively, such that the first and second gaskets are disposed adjacent to an edge of the electrolyte membrane, the second surface being opposite to the first surface, and forming a first main electrode layer on the first surface of the electrolyte membrane and inside the first gasket and forming a second electrode layer on the second surface of the electrolyte membrane and inside the second gasket.

In the bonding of a first gasket and a second gasket to the first surface and a second surface of the electrolyte membrane, the first gasket may be bonded to the first surface of the electrolyte membrane such that a portion of the first gasket overlaps the first sub-electrode layer. Additionally, in the formation of a first main electrode layer, the first main electrode layer may be formed on the first surface of the electrolyte membrane such that at least a portion of the first main electrode layer overlaps the first sub-electrode layer.

### BRIEF DESCRIPTION OF THE DRAWINGS

The above and other objects, features and advantages of the present disclosure will be more apparent from the following detailed description taken in conjunction with the accompanying drawings:

FIGS. 1 and 2 are views illustrating structures of fuel cells according to the related art;

FIG. 3 is a view illustrating a structure of a fuel cell according to an exemplary embodiment of the present disclosure;

FIG. 4 is a view illustrating a method for manufacturing the fuel cell of FIG. 3 according to an exemplary embodiment of the present disclosure; and

FIG. 5 is a view illustrating a structure of a fuel cell according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. When a component is described as “connected”, “coupled”, or “linked” to another component, they may mean the components are not only directly “connected”, “coupled”, or “linked” but also are indirectly “connected”, “coupled”, or “linked” via a third component.

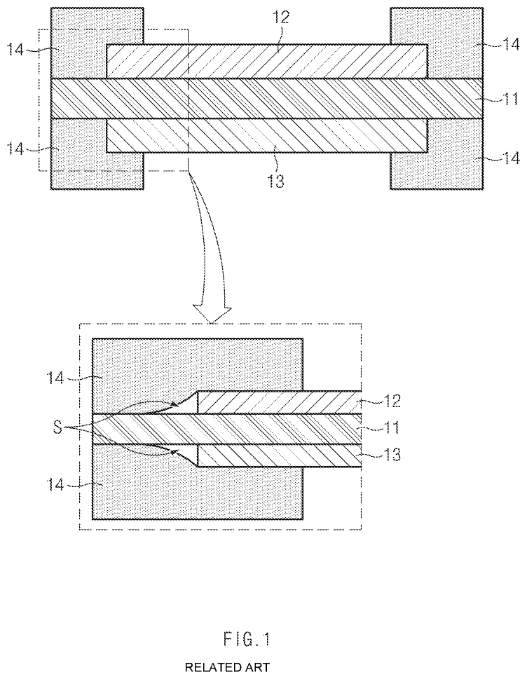

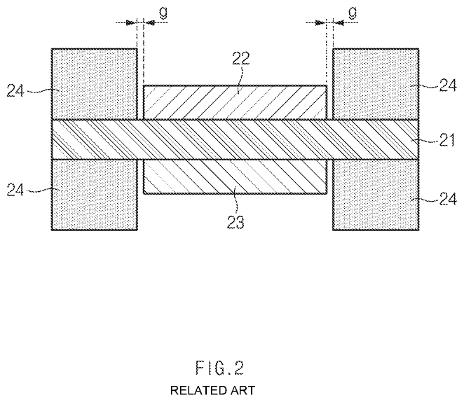

FIGS. 1 and 2 are views illustrating structures of fuel cells according to the related art. Descriptions of the structures of the fuel cells according to the related art will be given before descriptions of structures of fuel cells according to exemplary embodiments of the present disclosure.

Referring to FIG. 1, a fuel cell 10 according to an example of the related art includes an electrolyte membrane 11, an anode electrode layer 12, a cathode electrode layer 13, and gaskets 14. The electrolyte membrane 11 may allow hydrogen ions to move from the anode to the cathode. Gas diffusion layers (not illustrated) may be laminated on opposite sides of the electrolyte membrane 11, respectively, to promote diffusion of gas from the anode or the cathode to the electrolyte membrane 11 or promote diffusion of gas from the electrolyte membrane 11 to the anode or the cathode. The anode electrode layer 12 and the cathode electrode layer 13 are bonded to an anode side and a cathode side of the electrolyte membrane 11, respectively. For example, the anode electrode layer 12 and the cathode electrode layer 13 may be transferred on the electrolyte membrane 11.

A fuel cell stack includes a plurality of fuel cells stacked in a predetermined stack direction. Therefore, the plurality of fuel cells have to be spaced apart from each other by a predetermined distance to supply hydrogen or air necessary for power generation to the plurality of fuel cells. Gaskets are provided to support the plurality of fuel cells while spacing the plurality of fuel cells apart from each other by the predetermined distance. Additionally, the gaskets 14 may be disposed on an anode side and a cathode side of the fuel cell 10. The gaskets 14 may be formed along the edge of the fuel cell 10. For example, the gaskets 14 may be formed in a ring shape and may be disposed along the periphery of the fuel cell 10 to form an anode-side space and a cathode-side space in which the anode electrode layer 12 and the cathode electrode layer 13 are located, respectively.

Referring to FIG. 1, in the structure of the fuel cell 10 according to the example of the related art, an inside end of the anode-side gasket 14 may overlap the anode electrode layer 12. Furthermore, an inside end of the cathode-side gasket 14 may overlap the cathode electrode layer 13 to minimize spacing spaces between the gaskets 14 and the electrode layers 12 and 13. For example, when the gaskets 14 and the electrode layers 12 and 13 are formed not to have spacing therebetween and vertically overlap each other, gaps may be formed between the gaskets 14 and the electrode layers 12 and 13 due to a manufacturing tolerance.

When the gaskets 14 and the electrode layers 12 and 13 have gaps therebetween, the areas of the electrolyte membrane 11 that correspond to the gaps are exposed to the anode and the cathode without being covered with the gaskets 14 and the electrode layers 12 and 13. Accordingly, water produced in a power generation process flows to the exposed areas of the electrolyte membrane 11, causing degradation in durability of the electrolyte membrane 11. The fuel cell 10 according to the example of the related art has the structure in which the inside end of the anode-side gasket 14 overlaps the anode electrode layer 12 and the inside end of the cathode-side gasket 14 overlaps the cathode electrode layer 13. Nevertheless, referring to an enlarged view in FIG. 1, spacing spaces S are formed between the electrolyte membrane 11 and the gaskets 14 due to steps between the electrolyte membrane 11 and the electrode layers 12 and 13, causing the aforementioned problem.

Referring to FIG. 2, in the structure of a fuel cell 20 according to another example of the related art, gaskets 24 may not overlap an anode electrode layer 22 and a cathode electrode layer 23. In this case, gaps g are formed between the gaskets 24 and the electrode layers 22 and 23, and hydrogen or air in the anode and the cathode permeates across the areas of an electrolyte membrane 21 corresponding to the gaps g to generate radicals, thereby causing damage to the electrolyte membrane 21 and hence degradation in durability of the electrolyte membrane 21.

Accordingly, the present disclosure that has been made to solve the aforementioned problems occurring in the related art relates to a structure of a fuel cell for improving vulnerability of a bonding structure between an electrolyte membrane and a gasket and enhancing durability of the electrolyte membrane, and a method for manufacturing the fuel cell. More specifically, fuel cells according to exemplary embodiments of the present disclosure have a basic feature wherein the fuel cells include an electrolyte membrane, a first electrode layer, a second electrode layer, a first gasket, and a second gasket, in which the first electrode layer includes a first main electrode layer disposed on a first surface of the electrolyte membrane and inside the first gasket and a first sub-electrode layer having a portion inserted between the first main electrode layer and the electrolyte membrane and a portion inserted between the first gasket and the electrolyte membrane.

Hereinafter, features of the fuel cells according to the exemplary embodiments of the present disclosure will be described in more detail.

### First Embodiment

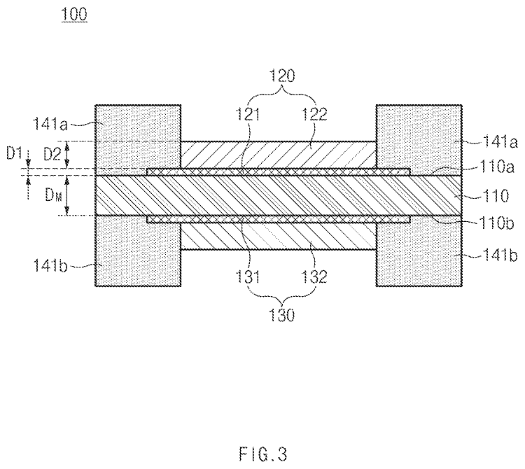

FIG. 3 is a view illustrating a structure of a fuel cell 100 according to an exemplary embodiment of the present disclosure. In this exemplary embodiment, a first electrode layer 120 and a second electrode layer 130 may be disposed on a first surface 110a and a second surface 110b of an electrolyte membrane 110, respectively, in which the second surface 110b is opposite to the first surface 110a. One of the first and second electrode layers 120 and 130 is an anode electrode layer, and the other is a cathode electrode layer. In other words, one of the first and second electrode layers 120 and 130 is an anode electrode layer on an anode side of the electrolyte membrane 110, and the other is a cathode electrode layer on a cathode side of the electrolyte membrane 110.

A first gasket 141a and a second gasket 141b may be disposed on the first surface 110a and the second surface 110b of the electrolyte membrane 110, respectively, to be adjacent to the edge of the electrolyte membrane 110. The first and second gaskets 141a and 141b may have a ring shape that extends along the edge of the electrolyte membrane 110. Accordingly, the first gasket 141a and the second gasket 141b may provide an anode space and a cathode space in which the first electrode layer 120 and the second electrode layer 130 may be disposed, respectively.

The first electrode layer 120 may be formed to have about the same height as, or a smaller height than, the first gasket 141a. The second electrode layer 130 may be formed to have about the same height as, or a smaller height than, the second gasket 141b. In other words, the first and second electrode layers 120 and 130 may be formed not to further protrude beyond the first and second gaskets 141a and 141b, and hence electrode layers of two adjacent fuel cells 100 may be prevented from contacting each other when a plurality of fuel cells 100 are stacked.

The first electrode layer 120 may include a first main electrode layer 122 disposed on the first surface 110a of the electrolyte membrane 110 and inside the first gasket 141a. The first electrode layer 120 may include a first sub-electrode layer 121 that has a first portion inserted between the first main electrode layer 122 and the electrolyte membrane 110 and a second portion inserted between the first gasket 141a and the electrolyte membrane 110. The first sub-electrode layer 121 may have a smaller thickness than the first main electrode layer 122. In other words, the thickness D1 of the first sub-electrode layer 121 may be less than the thickness D2 of the first main electrode layer 122. For example, the first sub-electrode layer 121 may have a thickness of about 0.01 μm to 1 μm.

In a process of manufacturing the fuel cell 100, an adhesive material may be applied between the first gasket 141a and the electrolyte membrane 110 to bond the first gasket 141 and the electrolyte membrane 110 together. The adhesive material may form an adhesive layer (not illustrated) between the first gasket 141a and the electrolyte membrane 110. For example, the thickness of the adhesive material applied between the first gasket 141a and the electrolyte membrane 110 in the manufacturing process of the fuel cell 100 may be about 5 μm. The first sub-electrode layer 121 may have the thickness D1 that is less than the thickness of the adhesive material applied between the first gasket 141a and the electrolyte membrane 110. Alternatively, the first sub-electrode layer 121 may have the thickness D1 that is less than the thickness of the adhesive layer formed between the first gasket 141a and the electrolyte membrane 110.

Furthermore, the thickness D1 of the first sub-electrode layer 121 may be relatively small, compared with the thickness D_{M} of the electrolyte membrane 110. The thickness of the first sub-electrode layer 121 may be relatively small, compared with the thicknesses of the first main electrode layer 122, the electrolyte membrane 110, and the first gasket 141a. Accordingly, the height of a step (e.g., a gradation, tread or the like) between the first sub-electrode layer 121 and the electrolyte membrane 110 may be minimized, and even though a spacing space may be formed between the first gasket 141a and the electrolyte membrane 110 due to the step between the first sub-electrode layer 121 and the electrolyte membrane 110, the adhesive material may fill the spacing space in the process of bonding the first gasket 141a to the electrolyte membrane 110.

The first main electrode layer 122 may cover the entirety of an area where the first surface 110a of the electrolyte membrane 110 is surrounded by the first gasket 141a. In other words, referring to FIG. 3, the shape of the first main electrode layer 122 toward the edge of the electrolyte membrane 110 may be restricted by the first gasket 141a. Thus, the edge portion of the first main electrode layer 122 may contact an inside end of the first gasket 141a.

The first main electrode layer 122 and the first sub-electrode layer 121 may be formed of the same material. When the first main electrode layer 122 and the first sub-electrode layer 121 have different compositions, resistance at the interface between the first main electrode layer 122 and the first sub-electrode layer 121 may increase due to the bonding of the heterogeneous materials, and therefore power generation performance may be degraded. However, depending on materials, different compositions of the first main electrode layer 122 and the first sub-electrode layer 121 may help to enhance power generation performance and achieve other objectives. Therefore, in such a case, the first main electrode layer 122 and the first sub-electrode layer 121 may be formed of heterogeneous materials.

The second electrode layer 130 may include a second main electrode layer 132 and a second sub-electrode layer 131. The second main electrode layer 132 may be disposed on the second surface 110b of the electrolyte membrane 110 and inside the second gasket 141b. The second sub-electrode layer 131 may have a first portion inserted between the second main electrode layer 132 and the electrolyte membrane 110 and a second portion inserted between the second gasket 141b and the electrolyte membrane 110.

The description of the first electrode layer 120 may be applied to the second electrode layer 130. In other words, the second electrode layer 130 may be formed or implemented by the same method as, or a method equivalent to, that of the first electrode layer 120. In an exemplary embodiment, the second electrode layer 130 may be implemented with only one electrode layer instead of the main electrode layer and the sub-electrode layer if the second electrode layer 130 is as thin as the first sub-electrode layer 121. A plurality of fuel cells 100 having the above configuration may be stacked to form a fuel cell stack.

According to the above-configured fuel cells 100, durability of the fuel cell stack may be enhanced by improving separation between the electrolyte membrane 110 and the gaskets 141a and 141b. Furthermore, the first sub-electrode layer 121 may be thinly printed on the electrolyte membrane 110 to prevent gas from permeating across the electrolyte membrane 110 from the anode to the cathode or vice versa, thereby preventing damage to the electrolyte membrane 110 and thus enhancing durability of the electrolyte membrane 110. In addition, the first main electrode layer 122 may be formed to be smaller in area than the first sub-electrode layer 121. Therefore, the amount of material used to form an electrode may be reduced compared to the structures of the fuel cells according to the related art.

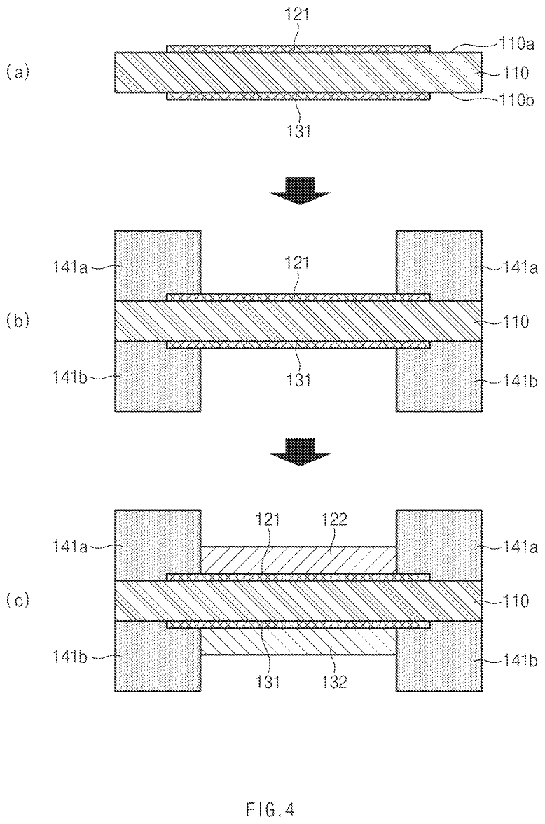

FIG. 4 is a view illustrating a method for manufacturing the fuel cell of FIG. 3. A method for manufacturing a fuel cell according to an exemplary embodiment of the present disclosure will be described below. First, an intermediate electrolyte-membrane product that includes the electrolyte membrane 110, the first sub-electrode layer 121 formed on the first surface 110a of the electrolyte membrane 110, and the second sub-electrode layer 131 formed on the second surface 110b of the electrolyte membrane 110 may be prepared (refer to (a) of FIG. 4).

The process of preparing the intermediate electrolyte-membrane product may include forming the first sub-electrode layer 121 on the first surface 110a of the electrolyte membrane 110 and forming the second sub-electrode layer 131 on the second surface 110b of the electrolyte membrane 110. In particular, the first sub-electrode layer 121 may be formed to a thickness of about 0.01 μm to 1 μm. The second sub-electrode layer 131 may be formed to a thickness of about 0.01 μm to 1 μm.

The first sub-electrode layer 121 and the second sub-electrode layer 131 may be formed using at least one of well-known methods such as ink-jet printing, laser printing, roll to roll, and the like. Further, the first gasket 141a may be bonded to the first surface 110a of the electrolyte membrane 110 to be adjacent to the edge of the electrolyte membrane 110, and the second gasket 141b may be bonded to the second surface 110b of the electrolyte membrane 110 to be adjacent to the edge of the electrolyte membrane 110 (refer to (b) of FIG. 4).

Particularly, the first gasket 141a may be bonded to the electrolyte membrane 110 such that the inside end of the first gasket 141a overlaps the first sub-electrode layer 121. In other words, the first gasket 141a may be bonded to the electrolyte membrane 110 such that a portion of the first sub-electrode layer 121 is inserted between the first gasket 141a and the electrolyte membrane 110. Similarly, the second gasket 141b may be bonded to the electrolyte membrane 10 such that an inside end of the second gasket 141b overlaps the second sub-electrode layer 131. In other words, the second gasket 141b may be bonded to the electrolyte membrane 110 such that a portion of the second sub-electrode layer 131 is inserted between the second gasket 141b and the electrolyte membrane 110.

Thereafter, the first main electrode layer 122 may be formed on the first surface 110a of the electrolyte membrane 110 and inside the first gasket 141a, and the second main electrode layer 132 may be formed on the second surface 110b of the electrolyte membrane 110 and inside the second gasket 141b (refer to (c) of FIG. 4). In particular, the first main electrode layer 122 may be formed on the first surface 110a of the electrolyte membrane 110 such that at least a portion of the first main electrode layer 122 overlaps the first sub-electrode layer 121. In this exemplary embodiment, the entire first main electrode layer 122 may be formed on the first sub-electrode layer 121. This process may include forming the first main electrode layer 122 on the first surface 110a of the electrolyte membrane 110 without a gap between the first main electrode layer 122 and the first gasket 141a with respect to a direction perpendicular to the stack direction in which the electrolyte membrane 110, the firsts sub-electrode layer 121, and the second electrode layer 130 are stacked.

The second main electrode layer 132 may be formed on the second surface 110b of the electrolyte membrane 110 such that at least a portion of the second main electrode layer 132 overlaps the second sub-electrode layer 131. In this exemplary embodiment, the entire second main electrode layer 132 may be formed on the second sub-electrode layer 131. This process may include forming the second main electrode layer 132 on the second surface 110b of the electrolyte membrane 110 without a gap between the second main electrode layer 132 and the second gasket 141b with respect to the perpendicular direction to the stack direction.

The first main electrode layer 122 and the second main electrode layer 132 may be formed using at least one of well-known methods such as ink-jet printing, laser printing, hot pressing, and the like. When the first main electrode layer 122 is formed, the first gasket 141a serves as a mold and thus, the first main electrode layer 122 may be formed to match the space provided by the first gasket 141a. In other words, the first gasket 141a may restrict the shape of the first main electrode layer 122 when the first main electrode layer 122 is formed.

When the second main electrode layer 132 is formed, the second gasket 141b serves as a mold and thus, the second main electrode layer 132 may be formed to match the space provided by the second gasket 141b. Accordingly, the first and second main electrode layers 122 and 132 may be formed in the shape of the fuel cell 100 according to this exemplary embodiment.

### Second Embodiment

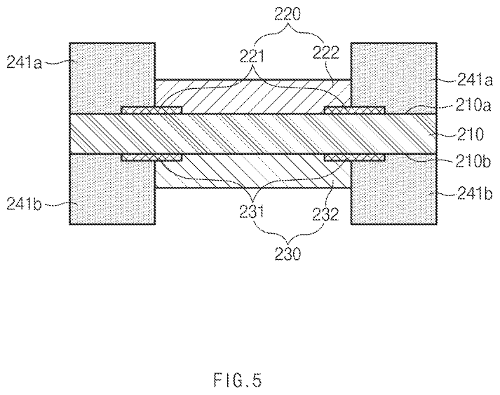

FIG. 5 is a view illustrating a structure of a fuel cell 200 according to an exemplary embodiment of the present disclosure. The following description taken in conjunction with FIG. 5 will be focused on the difference between the fuel cell 200 according to a second exemplary embodiment of the present disclosure and the above-described fuel cell 100 according to the first exemplary embodiment of the present disclosure. The fuel cell 200 according to the second exemplary embodiment is distinctly different from the fuel cell 100 according to the first exemplary embodiment in terms of first and second sub-electrode layers 221 and 231.

Referring to FIG. 5, the first sub-electrode layer 221 may include a portion inserted between a first gasket 241a and an electrolyte membrane 210. In particular, the first sub-electrode layer 221 may be formed such that the edge portion of a first main electrode layer 222 overlaps the first sub-electrode layer 221, but the central portion of the first main electrode layer 222 directly touches or contacts the electrolyte membrane 210. In other words, the first sub-electrode layer 221 may be formed in a ring shape such that a portion (e.g., a first portion) thereof is inserted between the first main electrode layer 222 and the electrolyte membrane 210 and the remaining portion (e.g., a second portion) is inserted between the first gasket 241a and the electrolyte membrane 210.

The description of the first electrode layer 220 may be applied to a second electrode layer 230. In other words, the second sub-electrode layer 231 and a second main electrode layer 232 of the second electrode layer 230 may be formed in the same way as the first sub-electrode layer 221 and the first main electrode layer 222 of the first electrode layer 220. According to the above-configured fuel cell 200 according to the second exemplary embodiment, durability of a fuel cell stack may be enhanced by improving separation between the electrolyte membrane 210 and the first and second gaskets 241a and 241b. Furthermore, the first sub-electrode layer 221 may be thinly printed on the electrolyte membrane 210 to prevent gas from permeating across the electrolyte membrane 110 from the anode to the cathode or vice versa, thereby preventing damage to the electrolyte membrane 210 and thus enhancing durability of the electrolyte membrane 210.

According to the exemplary embodiments of the present disclosure, at least the following effects are achieved. The fuel cells include the first main electrode layer disposed on one surface of the electrolyte membrane and inside the first gasket and the first sub-electrode layer having the portion inserted between the first main electrode layer and the electrolyte membrane and the portion inserted between the first gasket and the electrolyte membrane, thereby preventing separation between the electrolyte membrane and the first gasket.

In addition, the fuel cells having the above-described structures may minimize the gaps between the gaskets and the electrode layers, or even though gaps are present between the gaskets and the main electrode layers, the sub-electrode layers formed on the electrolyte membrane may prevent the electrolyte membrane from being brought into direct contact with air or hydrogen. Accordingly, damage to the electrolyte membrane due to gas permeating across the electrolyte membrane may be prevented. Consequently, vulnerability of the bonding structure between the electrolyte membrane and the gaskets may be improved, and durability of the electrolyte membrane may be enhanced.

Effects of the present disclosure are not limited to the aforementioned effects, and any other effects not mentioned herein will be clearly understood from the accompanying claims by those skilled in the art to which the present disclosure pertains. Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A fuel cell, comprising:
an electrolyte membrane;
a first electrode layer and a second electrode layer disposed on a first surface and a second surface of the electrolyte membrane, respectively, the second surface being opposite to the first surface, wherein one of the first and second electrode layers is an anode electrode layer and the other is a cathode electrode layer; and
a first gasket and a second gasket disposed on the first surface and the second surface of the electrolyte membrane, respectively, to be adjacent to an edge of the electrolyte membrane,
wherein the first electrode layer includes:
a first main electrode layer disposed on the first surface of the electrolyte membrane and inside the first gasket; and
a first sub-electrode layer having a first portion inserted between the first main electrode layer and the electrolyte membrane and a second portion inserted between the first gasket and the electrolyte membrane.

2. The fuel cell of claim 1, wherein the first sub-electrode layer has a thickness that is less than a thickness of the first main electrode layer.

3. The fuel cell of claim 2, wherein an adhesive material is applied to a predetermined thickness between the first gasket and the electrolyte membrane to bond the first gasket and the electrolyte membrane together, and wherein the first sub-electrode layer has a smaller thickness than the adhesive material applied between the first gasket and the electrolyte membrane.

4. The fuel cell of claim 1, wherein the first main electrode layer has a shape that covers an entire area where the first surface of the electrolyte membrane is surrounded by the first gasket.

5. The fuel cell of claim 1, wherein the first main electrode layer and the first sub-electrode layer are formed of a same material.

6. The fuel cell of claim 1, wherein the first sub-electrode layer is formed in a ring shape, and an inside end of the first sub-electrode layer in the ring shape is inserted between the first main electrode layer and the electrolyte membrane, and an outside end of the first sub-electrode layer in the ring shape is inserted between the first gasket and the electrolyte membrane.

7. The fuel cell of claim 1, wherein the second electrode layer includes:
a second main electrode layer disposed on the second surface of the electrolyte membrane and inside the second gasket; and
a second sub-electrode layer having a first portion inserted between the second main electrode layer and the electrolyte membrane and a second portion inserted between the second gasket and the electrolyte membrane.

8. A method for manufacturing a fuel cell, comprising:
preparing an intermediate electrolyte-membrane product that includes an electrolyte membrane and a first sub-electrode layer formed on a first surface of the electrolyte membrane;
bonding a first gasket and a second gasket to the first surface and a second surface of the electrolyte membrane, respectively, to disposed the first and second gaskets adjacent to an edge of the electrolyte membrane, the second surface being opposite to the first surface; and
forming a first main electrode layer on the first surface of the electrolyte membrane and inside the first gasket and forming a second electrode layer on the second surface of the electrolyte membrane and inside the second gasket,
wherein the first gasket is bonded to the first surface of the electrolyte membrane such that a portion of the first gasket overlaps the first sub-electrode layer, and
wherein the first main electrode layer is formed on the first surface of the electrolyte membrane such that at least a portion of the first main electrode layer overlaps the first sub-electrode layer.

9. The method of claim 8, further comprising:
forming the first sub-electrode layer to a thickness of about 0.01 μm to 1 μm on the first surface of the electrolyte membrane.

10. The method of claim 8, further comprising:
forming the first main electrode layer on the first surface of the electrolyte membrane without a gap between the first main electrode layer and the first gasket with respect to a direction perpendicular to a stack direction in which the electrolyte membrane, the first sub-electrode layer, and the second electrode layer are stacked.
